(19) United States
(12) Patent Application Publication
(10) Pub. No.: US 2019/0238171 A1
(43) Pub. Date: Aug. 1, 2019

(54) Multi-Layer Polymeric Protective Sheet, Related Articles and Methods

(71) Applicant: entrotech, inc., Columbus, OH (US)

(72) Inventor: James E. McGuire, Jr., Palm Beach, FL (US)

(73) Assignee: entrotech, inc., Columbus, OH (US)

(21) Appl. No.: 16/326,419

(22) PCT Filed: Sep. 1, 2017
(86) PCT No.: PCT/US17/49969

§ 371 Date: Feb. 19, 2019

(51) Int. Cl. H04B 1/3888; B32B 27/40; B32B 27/08; B32B 7/12; B32B 27/20

(52) U.S. Cl. CPC H04B 1/3888; B32B 27/40; B32B 27/08; B32B 7/12; B32B 2264/10; B32B 2307/746; B32B 2307/54; B32B 2571/00; B32B 27/20

(57) ABSTRACT

Multi-layer polymeric protective sheets of the invention are usefully applied to a variety of articles, including touchscreen displays on electronic devices. Articles of the invention include display screen protectors having not only glass-like properties, but also flexural integrity associated with conventional screen protectors based on polymeric films. In an exemplary embodiment, a multi-layer polymeric protective sheet comprises a first polyurethane layer and a distinct second polyurethane layer. The protective sheet is essentially free of tempered glass and the coefficient-of-friction of an outwardly exposed surface of the protective sheet is less than about 0.40.

### CROSS-REFERENCE TO RELATED APPLICATIONS

This application claims the benefit of U.S. Provisional Patent Application No. 62/382,706, filed on Sep. 1, 2016, which is incorporated by reference herein in its entirety.

### BACKGROUND OF THE INVENTION

The present invention relates to multi-layer polymeric protective sheets, which can be applied to a variety of articles and provide improved protective properties, as well as related articles and methods.

Multi-layer polymeric protective sheets of the invention comprise multiple polymeric films. Polymeric films are applied to surfaces of articles for a number of reasons. One significant application for polymeric films is for providing a protective covering on an article's surface. For example, certain polymeric films are capable of protecting an article's surface from damage during use of the article. Such protective polymeric films are often adhered to an article's surface to minimize damage thereto.

Applications for protective and other polymeric films are becoming increasingly desirable as widespread use of consumer electronic devices soars. Many consumer electronic devices employ a display screen that can easily be scratched, cracked, or otherwise damaged. For example, most personal data assistants, cellular phones, tablet computers, laptop computers, notebook computers, and similar devices include a display screen for viewing data and/or images thereon. In order to optimize viewing efficiency, such display screens are highly engineered to maximize clarity of data and images viewed thereon. Unfortunately, however, such display screens are often prone to scratching, cracking, or other types of damage, especially as users of such electronic devices tote the devices haphazardly through their daily lives.

Conventionally, when protective polymeric films are applied to surfaces of electronic devices, the goal is to provide a protective covering on the display or other surface of the device that does not significantly diminish desired qualities of the underlying surface. Importantly, when a protective polymeric film is applied to an optical display screen, the film is selected to have desired optical clarity. Then, when the polymeric film is applied to the optical display screen, it is important to maintain desired optical clarity of the film as well as views of the display screen therethrough.

External glass sheets are gaining popularity for adherence to such display screens. For example, tempered glass screen protector sheets provide a more natural feel when operating a touch-sensitive display screen (also referred to herein as a touchscreen display) therethrough. Some commercially available glass screen protector sheets include a layer of tempered glass within a multi-layer assembly. INVISIBLESHIELD GLASS screen protectors available from Zaag, Inc. (Salt Lake City, Utah) and TECH ARMOR BALLISTIC GLASS and TECH ARMOR EDGE TO EDGE BALLISTIC GLASS screen protectors available from Tech Armor (Redondo Beach, Calif.) are just a few examples.

Although the feel of glass sheets appeals to consumers, application of such sheets to display screens can be challenging in that glass does not have the flexural integrity associated with polymeric films conventionally used for protection of display screens—e.g., the original INVISIBLESHIELD screen protector available from Zaag, Inc. (Salt Lake City, Utah). The lack of flexural integrity of glass sheets makes it difficult to re-apply such a screen protector when it becomes misaligned during, for example, initial installation of the same.

Another shortcoming of commercially available glass sheets is that they have a tendency to provide false implied promises of adequate protection of the underlying display screen. It is often not until the display screen on an electronic device fitted with a glass sheet breaks when dropped that consumers recognize the shortfalls of such “protective” sheets.

It is desirable to provide alternative assemblies and methods for application of multi-layer polymeric protective sheets to surfaces of articles, such as touchscreen displays on electronic devices. Particularly desirable are alternative screen protector assemblies having not only glass-like properties, but also flexural integrity associated with conventional screen protectors based on polymeric films.

### SUMMARY OF THE INVENTION

Multi-layer polymeric protective sheets of the invention are usefully applied to a variety of articles, including touchscreen displays on electronic devices. Articles of the invention include display screen protectors having not only glass-like properties, but also flexural integrity associated with conventional screen protectors based on polymeric films. In an exemplary embodiment, a multi-layer polymeric protective sheet comprises a first polyurethane layer and a distinct second polyurethane layer.

According to one aspect of the invention, the first polyurethane layer has a thickness of about 100 microns to about 200 microns in the exemplary embodiment. Preferably, in such an embodiment, the first polyurethane layer comprises a high modulus, thermoset, crosslinked, web-polymerized polyurethane. According to another aspect of the invention, the second polyurethane layer has a thickness of about 75 microns to about 300 microns in the exemplary embodiment. Preferably, in such an embodiment, the second polyurethane layer comprises a super high modulus, thermoset, crosslinked, web-polymerized polyurethane.

Storage modulus of each of the first polyurethane layer and the second polyurethane layer is at least about 500 MPa at 25° C. when tested according to the Storage Modulus Test Method described herein according to an exemplary embodiment. Preferably, storage modulus of the second polyurethane layer so tested is at least about 20% greater than the storage modulus of the first polyurethane layer so tested.

A peak tan delta value of each of the first polyurethane layer and the second polyurethane layer occurs at a temperature of about 30° C. or about 40° C. to about 100° C. when tested according to the Tan Delta Test Method described herein according to an exemplary embodiment.

Glass transition temperature of each of the first polyurethane layer and the second polyurethane layer is at least about 25° C. or at least about 35° C. when tested according to the DSC Test Method described herein according to an exemplary embodiment. In any event, preferably, the glass transition temperature of the second polyurethane layer is at least about 5° C. greater than the glass transition temperature of the first polyurethane layer so tested.

According to one embodiment, a multi-layer polymeric protective sheet of the invention comprises a first polyurethane layer and a distinct second polyurethane layer, wherein the protective sheet is essentially free of tempered glass, and wherein coefficient-of-friction of an outwardly exposed surface of the protective sheet is less than about 0.40. According to a further embodiment, the coefficient-of-friction of the outwardly exposed surface of the protective sheet is less than about 0.35.

An exemplary protective sheet consists essentially of sequential layers as follows: a self-wetting layer; a rigid layer; a first adhesive bonding layer; the first polyurethane layer; a second adhesive bonding layer; and the second polyurethane layer comprising the outwardly exposed surface. According to a further embodiment, the protective sheet consists essentially of sequential layers as follows: a self-wetting layer; a rigid layer; a first adhesive bonding layer; the first polyurethane layer; a second adhesive bonding layer; and an outermost polymeric layer comprising the outwardly exposed surface. In one embodiment, the outermost polymeric layer comprises an acrylic-based polyurethane formed from aliphatic polyols and aliphatic polyisocyanate polymer. In another embodiment, which may overlap with the embodiment just described, the outermost polymeric layer is nanomodified with sapphire.

Overall thickness of the protective sheet is generally less than about 635 microns in exemplary embodiments. Depending on the application, overall thickness of the protective sheet is preferably about 0.4 millimeter to about 2.0 millimeters.

Articles to which multi-layer polymeric protective sheets of the invention are applied generally comprise at least one surface to which a multi-layer polymeric protective sheet of the invention is applied to at least a portion thereof. To assist in useful and adequate application to an article, the protective sheet can be thermoformable to assist in such application.

In an exemplary embodiment, a multi-layer polymeric protective sheet is applied to a display screen (e.g., touchscreen display) of an electronic device (e.g., smartphone). According to one aspect of this embodiment, coefficient-of-friction of the outwardly exposed surface of the protective sheet is less than a coefficient-of-friction of the underlying display screen to which the multi-layer polymeric protective sheet is applied. According to another aspect of this embodiment, coefficient-of-friction of the outwardly exposed surface of the protective sheet is no more than about 25% greater or no more than about 20% greater or even no more than about 15% greater than a coefficient-of-friction of the underlying display screen to which the multi-layer polymeric protective sheet is applied.

In general, a method of using the protective sheet of the invention protect a surface on an article comprises providing the protective sheet and applying the sheet to the surface of the article. In an exemplary embodiment, the surface of the article comprises a display screen on an electronic device and the protective sheet is formed and sized to not only cover the display screen to which it is applied, but also large enough to cover at least a portion of a case of the electronic device adjacent the display screen. For example, the protective sheet can be thermoformed according to such methods.

Methods of forming the protective sheet include those wherein at least one of the first polyurethane layer and the second polyurethane layer is in-situ polymerized and those wherein each of the layers within the protective sheet is formed before assembly into the protective sheet.

### BRIEF DESCRIPTION OF THE SEVERAL VIEWS OF THE DRAWINGS

FIG. 1A is a cross-sectional representation of one embodiment of a multi-layer polymeric protective sheet of the invention.

FIG. 1B is a cross-sectional representation of a further embodiment of the multi-layer polymeric protective sheet of FIG. 1A.

FIG. 2A is a top view of a multi-layer polymeric protective sheet of the invention.

FIG. 2B illustrates the multi-layer polymeric protective sheet of FIG. 2A in top and side views with a smartphone to which it is applied.

FIG. 2C illustrates the multi-layer polymeric protective sheet of FIG. 2A as a first part to be applied to a smartphone.

FIG. 2D is a bottom view of a second part of the multi-layer polymeric protective sheet to be applied to a smartphone in combination with the first part illustrated in FIG. 2C.

FIG. 2E illustrates the first and second parts of the polymeric protective sheet of FIGS. 2C and 2D in top and side views with a smartphone to which they are applied.

FIG. 2F illustrates the first and second parts of the polymeric protective sheet of FIGS. 2C and 2D in bottom view with the smartphone to which they are applied.

FIG. 3 is a graph of Loss Factor (also referred to as Tan Delta) versus Temperature for polyurethane layers used within multi-layer polymeric protective sheets of the invention as compared to conventional polyurethane and polycarbonate layers.

FIG. 4 is a graph of Storage Modulus versus Temperature for polyurethane layers used within multi-layer polymeric protective sheets of the invention as compared to conventional polyurethane and polycarbonate layers.

### DETAILED DESCRIPTION OF THE INVENTION

Multi-layer polymeric protective sheets according to the invention are capable of providing functionality that is understood by one of ordinary skill in the art to be, for example, protective, decorative, reflective, anti-reflective, fog-resistant, and/or for privacy. In any event, all polymeric protective sheets of the invention advantageously have improved glass-like properties—e.g., a smooth, unobstructed feel when operating a touchscreen display therethrough—as compared to conventional polymeric protective sheets, which feel relatively tacky or rough when moving a finger thereacross.

Preferably, the coefficient-of-friction of outwardly exposed surfaces of polymeric protective sheets of the invention is less than about 0.40, more preferably less than about 0.35, when tested according to the Coefficient-of-Friction Test Method described below.

According to another preferred embodiment, the coefficient-of-friction of outwardly exposed surfaces of polymeric protective sheets of the invention is no more than about 25% greater, more preferably no more than about 20% greater, and even more preferably no more than about 15% greater, than that of an underlying display screen to which the polymeric protective sheet is applied. In one embodiment, the coefficient-of-friction of outwardly exposed surfaces of polymeric protective sheets of the invention is less than that of an underlying display screen (e.g., the outermost layer on the iPhone 6 display screen, available from Apple, Inc. (Cupertino, Calif.)) to which the polymeric protective sheet is applied.

While multi-layer polymeric protective sheets of the invention may be referred to as “faux glass” or the like, as compared to screen protector assemblies based on tempered glass, however, protective sheets of the invention have improved flexural integrity. Thus, multi-layer polymeric protective sheets of the invention are essentially free of tempered glass in preferred embodiments.

Such assemblies may be applied to at least a portion of one or more surfaces of an article, such as surfaces on which data and/or images are visible (e.g., the surface of an optical display screen). When configured for application to a surface on which data and/or images are to be viewed, a polymeric protective sheet of the present invention may be transparent. Polymeric protective sheets configured for application to other surfaces, including surfaces through which data and/or images need not be clearly viewed, may be, for example, not only transparent, but also translucent or opaque. In further embodiments, polymeric protective sheets of the invention include one or more decorative features that enhance the look of a surface onto which they are to be applied.

In one embodiment, polymeric protective sheets can be effectively applied to one or more surfaces of an article, such as an electronic device. The invention is applicable to any of a number of articles, electronic or otherwise, such as, for example, consumer electronic devices. Exemplary embodiments of the invention include those applicable to consumer electronic devices, such as personal data assistants, cellular phones (e.g., smartphones), personal computers (e.g., tablet, laptop, and notebook computers), and similar devices that include a display screen for viewing data and/or images thereon. According to an exemplary embodiment, the consumer electronic device comprises a touchscreen display for control of the device. Such displays are particularly benefited by polymeric protective sheets having glass-like properties. According to other embodiments, polymeric protective sheets of the invention are applied to other types of surfaces that may benefit, aesthetically or otherwise, from a protective covering.

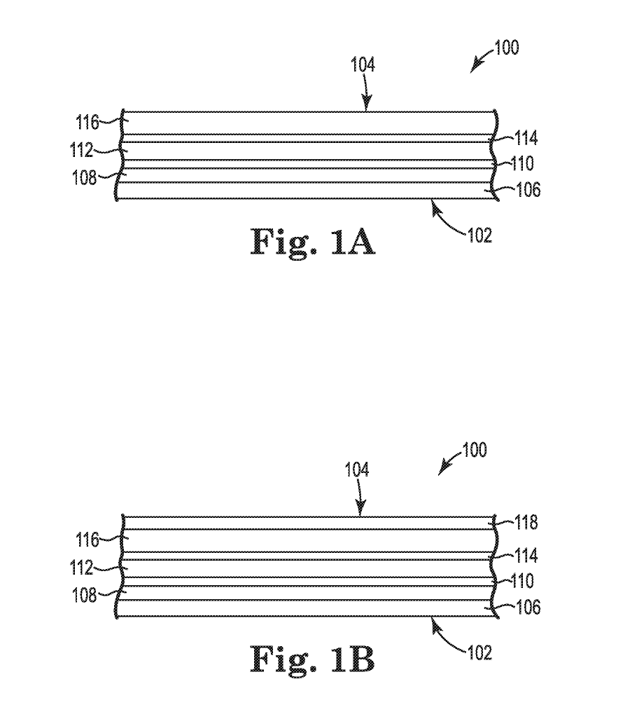

FIG. 1A illustrates one embodiment of a polymeric protective sheet 100 of the invention. Sequentially, from the outer surface 102 of the polymeric protective sheet 100 that is applied to a surface to be protected (not shown) to the outwardly exposed surface 104 of the polymeric protective sheet 100 after it is applied to the surface to be protected, the exemplary polymeric protective sheet 100 of the invention illustrated in FIG. 1A comprises: a self-wetting layer 106, a rigid layer 108, a first adhesive bonding layer 110, a first polyurethane layer 112, a second adhesive bonding layer 114, and a second polyurethane layer 116. While sequence and presence of layers may vary without departing from benefits of the invention in certain applications, polymeric protective sheets of the invention generally include at least a first polyurethane layer 112 and a distinct second polyurethane layer 116.

FIG. 1B illustrates a further embodiment of the polymeric protective sheet 100 of FIG. 1A, further comprising an outermost polymeric layer 118 as the outwardly exposed surface 104 of the polymeric protective sheet 100 after it is applied to the surface to be protected. In a preferred embodiment, the outermost polymeric layer 118 is nanomodified with sapphire.

Overall thickness of the polymeric protective sheet 100 is selected according to its intended application. For example, a polymeric protective sheet 100 can have a thickness of up to about 635 microns (25 mils). When used in conjunction with consumer electronic devices, for example, a polymeric protective sheet 100 having a total thickness of preferably about 0.4 millimeter to about 2.0 millimeters, or more preferably about 0.4 millimeter to about 1.0 millimeter, is used.

As used herein, “self-wetting” refers to a material having the ability to flow onto a surface relatively quickly and efficiently, typically by virtue of it having a lower surface energy than that of the surface on which it flows, and preferably pushing any bubbles in front of it to avoid trapping any air bubbles between the material and the surface. According to a further preferred embodiment, if bubbles do become entrapped, they are capable of being readily removed by application of light finger pressure in order to move any bubbles to the edge of a layer of the material.

The self-wetting layer 106 comprises any suitable chemistry and thickness. Preferably, the self-wetting layer 106 is a pressure-sensitive adhesive. In an exemplary embodiment, the self-wetting layer 106 comprises silicone. Commercially available silicone pressure-sensitive adhesives are obtainable, for example, from Dow Corning Corp. (Auburn, Mich.) under the trade designation, Dow Corning® Low-Adhesion, Low-Migration Silicone PSA.

The rigid layer 108 comprises any suitable thickness. In an exemplary embodiment, the rigid layer 108 is about 20 microns to about 70 microns thick.

The rigid layer 108 comprises any suitable chemistry. In an exemplary embodiment, the rigid layer 108 comprises biaxially-oriented polyethylene terephthalate. Biaxially-oriented polyethylene terephthalate is commercially available under, for example, the MYLAR trade designation from DuPont Teijin Films U.S. Limited Partnership (Chester, Va.). In another exemplary embodiment, the rigid layer 108 comprises chemistry similar to or the same as chemistry of the first polyurethane layer 112 or the second polyurethane layer 116.

The first adhesive bonding layer 110 and the second adhesive bonding layer 114 comprise any suitable chemistry and thickness, which may be the same or different. For example, pressure-sensitive adhesives, thermoplastics, and thermosets can be used for the bonding layers 110, 114. Acrylic, silicone, and polyurethane chemistries or mixtures thereof are exemplary pressure-sensitive adhesive chemistries. Acrylic, ethyl vinyl acetate, polyester, and polyurethane chemistries or mixtures thereof are exemplary thermoplastic chemistries. Acrylic, polyester, and polyurethane chemistries or mixtures thereof are exemplary thermoset chemistries. In an exemplary embodiment, the first adhesive bonding layer 110 and/or the second adhesive bonding layer 114 comprises an acrylic pressure sensitive adhesive available from entrochem, inc. (Columbus, Ohio) under the trade designation, ECA153. In an exemplary embodiment, thickness of each the first adhesive bonding layer 110 and the second adhesive bonding layer 114 does not exceed about 50 microns.

The first polyurethane layer 112 comprises any suitable thickness. In an exemplary embodiment, the first polyurethane layer 112 is about 75 microns to about 300 microns thick. In a further exemplary embodiment, the first polyurethane layer 112 is about 100 microns to about 200 microns thick. In a further exemplary embodiment, the first polyurethane layer 112 is about 100 microns to about 150 microns thick.

The first polyurethane layer 112 comprises any suitable chemistry. In one embodiment, the first polyurethane layer 112 comprises a high modulus, thermoset, crosslinked, web-polymerized polyurethane (also referred to herein as a “HM polyurethane” layer). According to one aspect of the invention, the HM polyurethane layer 112 has a storage modulus of at least about 500 MPa at 25° C. when tested according to the Storage Modulus Test Method described below. In further embodiments, the HM polyurethane layer 112 has a storage modulus of at least about 750 MPa, at least about 1,000 MPa, or at least about 1,500 MPa at 25° C. when so tested. According to another aspect of the invention, the HM polyurethane layer 112 has a peak (i.e., maximum) tan delta value occurring at a temperature of greater than about 30° C., more preferably greater than about 40° C., and less than about 100° C. when tested according to the Tan Delta Test Method described below.

As a standalone layer, HM polyurethane can be used as a substitute material in most applications in which polycarbonate products, such as those available from Saudi Basic Industries Corporation (SABIC) (Pittsfield, Mass.) under the LEXAN trade designation and those available from Covestro LLC (Pittsburgh, Pa.) under the MAKROLON trade designation, are conventionally used. However, unlike polycarbonate, HM polyurethane is less prone to catastrophic failure (e.g., by shattering) and more prone to localized damage (e.g., discrete nicks, fractures, and the like) when stressed. Further, substitutes for polycarbonate are desirable in that polycarbonate is known to include potentially harmful bisphenol-A subunits.

Preferably, the first polyurethane layer 112 has a glass transition temperature of at least about 25° C. when tested according to the DSC Test Method described below. In further embodiments, the first polyurethane layer 112 has a glass transition temperature of at least about 30° C. or at least about 35° C. when so tested.

The second polyurethane layer 116 comprises any suitable thickness. In an exemplary embodiment, the second polyurethane layer 116 is about 75 microns to about 300 microns thick. In a further exemplary embodiment, the second polyurethane layer 116 is about 100 microns to about 275 microns thick. In a further exemplary embodiment, the second polyurethane layer 116 is about 125 microns to about 250 microns thick.

The second polyurethane layer 116 comprises any suitable polyurethane-based chemistry. In general, the second polyurethane layer 116 has a lower impact strength than material comprising the first polyurethane layer 112. Further, the second polyurethane layer 116 has a storage modulus that is at least about twenty-percent, preferably at least about thirty-five-percent, greater than storage modulus of the first polyurethane layer 112 at 25° C. when tested according to the Storage Modulus Test Method described below.

In one embodiment, the second polyurethane layer 116 is a super high modulus, thermoset, crosslinked, web-polymerized polyurethane (also referred to herein as a “SHM polyurethane” layer). According to one aspect of the invention, the SHM polyurethane layer 112 has a storage modulus of at least 500 MPa at 25° C. when tested according to the Storage Modulus Test Method described below. In further embodiments, the SHM polyurethane layer 112 has a storage modulus of at least 750 MPa, at least about 1,000 MPa, or at least about 1,500 MPa at 25° C. when so tested. According to another aspect of the invention, the SHM polyurethane layer 112 has a peak (i.e., maximum) tan delta value occurring at a temperature of greater than about 30° C., more preferably greater than about 40° C., and less than about 100° C. when tested according to the Tan Delta Test Method described below.

As a standalone layer, SHM polyurethane can be used as a substitute material in most applications in which polymethylmethacrylate (PMMA) products, such as those available from Evonik Industries AG (Darmstadt, Germany) under the trade designations, PLEXIGLAS and ACRYLITE; from DuPont under the trade designation, LUCITE; and from Altuglas International, a subsidiary of Arkema Inc. (King of Prussia, Pa.), under the ALTUGLAS, OROGLAS, and PLEXIGLAS trade designations, are conventionally used. However, as opposed to PMMA products, which are typically thermoplastic, SHM polyurethane is thermoset. Further, unlike such PMMA products, SHM polyurethane typically shatters when bent at room temperature.

Beneficially, however, as the second polyurethane layer 116 has a higher storage modulus than conventional thermoplastic polyurethanes, but a lower storage modulus than conventional glass, it is able to accommodate higher strains (e.g., 2%, 5%, or even greater than 10% strain) without cracks propagating therethrough upon flexing of the layer. In addition to unintended occurrences, such flexure is expected to occur when installing a polymeric protective sheet on a surface of an article according to the invention.

Preferably, the second polyurethane layer 116 has a glass transition temperature of at least about 25° C. when tested according to the DSC Test Method described below. In further embodiments, the second polyurethane layer 116 has a glass transition temperature of at least about 30° C. or at least about 35° C. when so tested. In any event, it is preferred that the glass transition temperature of the second polyurethane layer 116 is at least about 3° C., more preferably at least about 5° C., and even more preferably at least about 10° C., greater than the glass transition temperature of the first polyurethane layer 112.

The outermost polymeric layer 118 comprises any suitable thickness and chemistry. In an exemplary embodiment, the outermost polymeric layer 118 is less than about 25 microns thick, preferably about 5 microns to about 15 microns thick. In a particularly preferred embodiment, the outermost polymeric layer 118 is about 5 microns thick.

Suitable materials for the outermost polymeric layer 118 are described as the “topcoat layer” in PCT Patent Application No. PCT/US17/21982, which is incorporated by reference herein in its entirety, and can be utilized in the present invention. For example, the topcoat layer can comprise as its base polymer a polycarbonate, a polyvinyl fluoride, a poly(meth)acrylate (e.g., a polyacrylate or a polymethacrylate), a polyurethane, modified (e.g., hybrid) polymers thereof, or combinations thereof. See U.S. Pat. No. 4,476,293 for a description of exemplary polycarbonate-based polyurethanes useful for the topcoat layer of the invention. See also U.S. Patent Publication No. US-2008-0286576-A1, incorporated herein by reference, for a description of further exemplary materials for the outermost polymeric layer 118.

Preferably, to maximize gloss retention, soil resistance, and other desirable performance properties, the outermost polymeric layer 118 is of relatively high molecular weight. That is, while the outermost polymeric layer 118 can be formed by extrusion according to some embodiments of the invention, it is preferably of a sufficient molecular weight that extrusion thereof is not practical (i.e., if a polyurethane, the polyurethane is not considered extrusion-grade polyurethane by those of ordinary skill in the art). In a preferred embodiment, the outermost polymeric layer 118 is in-situ polymerized. An exemplary preferred material for the outermost polymeric layer 118 comprises a thermoset, in situ-polymerized polyacrylic-urethane modified with nanosapphire, an aluminum oxide. Nanosapphire modifiers are commercially available from BYK Additives, a division of BYK-Chemie GmbH. For example, such modifiers are available from BYK Additives under the NANOBYK-3602 and NANOBYK-3610 trade designations. Given that the outermost polymeric layer 118 is formed on the second polyurethane layer 116, it becomes covalently bonded to the second polyurethane layer 116.

In addition to any described in conjunction with the foregoing description of individual layers, any suitable additives can be present in the polymeric protective sheet 100 and individual layers thereof as known to those skilled in the art and based on the intended application. Those skilled in the art are readily able to determine the amount of such additives to use for the desired effect.

Each of the individual layers of the multi-layer polymeric protective sheet is formed and assembled into a multi-layer protective sheet according to the invention according to the knowledge of those skilled in the art. In forming the rigid layer 108, for example, the rigid layer 108 can be formed on a separate carrier film (e.g., polyester film), resulting in a supported rigid layer 108, after which time the first adhesive bonding layer 110 and other sequential layers of the multi-layer polymeric protective sheet may be formed on the rigid layer 108. The supporting carrier film can then be then removed at some point in time, so that the underlying side of the rigid layer 108 is outwardly exposed or the self-wetting layer 106 can be formed thereon.

For preparation of the first adhesive bonding layer 110 and second adhesive bonding layer 114, any suitable method can be used. For example, as an alternative to direct (e.g., in-situ) formation of the first adhesive bonding layer 110 or second adhesive bonding layer 114 on an underlying layer, an adhesive film of the desired thickness can be cast onto a release film according to one embodiment and as known to those skilled in the art. In that embodiment, the adhesive film supported on the release film can then be assembled with an adjacent layer of the multi-layer polymeric protective sheet, with the release film being removed before further assembly of the multi-layer polymeric protective sheet.

In a preferred embodiment, while not otherwise limited in terms of methodology and order of assembly, at least one of the first polyurethane layer 112 and second polyurethane layer 116 is polymerized in-situ. According to a further aspect of this embodiment, each of the other individual layers of the multi-layer polymeric protective sheet is prepared before assembly into the final article. Any suitable method for formation of each of the other individual layers can be used as known to those skilled in the art.

For preparation of the outermost polymeric layer 118, any suitable method can be used. For example, a film comprising a polymeric layer of a desired thickness can be cast onto a smooth film (e.g., polyester film) according to one embodiment and as known to those skilled in the art to form a supported polymeric layer. In one embodiment, the supported polymeric layer is then assembled with the remaining layers of the multi-layer polymeric protective sheet. The smooth film used for formation of the outermost polymeric layer 118 can remain in the assembly until application of the multi-layer polymeric protective sheet to a surface of an article in order to provide extra protection during shipping and storage of the sheet. According to another embodiment, the outermost polymeric layer 118 is formed by direct coating that polymeric layer onto the adjacent layer of the multi-layer polymeric protective sheet according to conventional methods.

While the above-described processes entail formation of individual layers and then adherence of those layers together to form the multi-layer polymeric protective sheet, according to another embodiment of the invention, some of the sheet's layers can be formed simultaneously by, for example, co-extrusion of the polymerizable compositions starting in their liquid form, which step is typically performed at a temperature below about 40° C.—e.g., about room temperature in one embodiment. In addition to the first polyurethane layer 112 and the second polyurethane layer 116, other layers may be polymerized in-situ into a film format as described in, for example, U.S. Pat. No. 8,828,303 and U.S. Patent Publication No. US-2011-0137006-A1. No matter what method is used, the process can be a continuous or batch process.

The polymeric protective sheets of the invention can be provided in planar or non-planar configurations, depending on the topography of the surface on the article to which it will be applied. Advantageously, due to the polymeric nature of the layers within protective sheets of the invention, flexural integrity of the protective sheets is greater than that of screen protectors relying on tempered glass layers.

In one embodiment, polymeric protective sheets of the invention are formed and sized to approximate the size of a display screen to which they are applied. As used herein, “display screen” is to be understood to include not only portions of a surface through which data and/or images are viewed, but all adjacent portions of that same material surface in further embodiments. According to this embodiment, the polymeric protective sheet may be planar or non-planar, the latter case existing when the electronic device has a non-planar display screen (e.g., as is the case with the Samsung GALAXY 6S EDGE smartphone available from and the iPhone 6 available from Apple, Inc. (Cupertino, Calif.)).

In another embodiment, polymeric protective sheets of the invention are formed (e.g., by thermoforming) and sized (e.g., by laser cutting) to not only cover the display screen to which they are applied, but also such that they are large enough to cover at least a portion of the metal and/or plastic case adjacent the display screen. According to this embodiment, the polymeric protective sheet may be planar or non-planar.

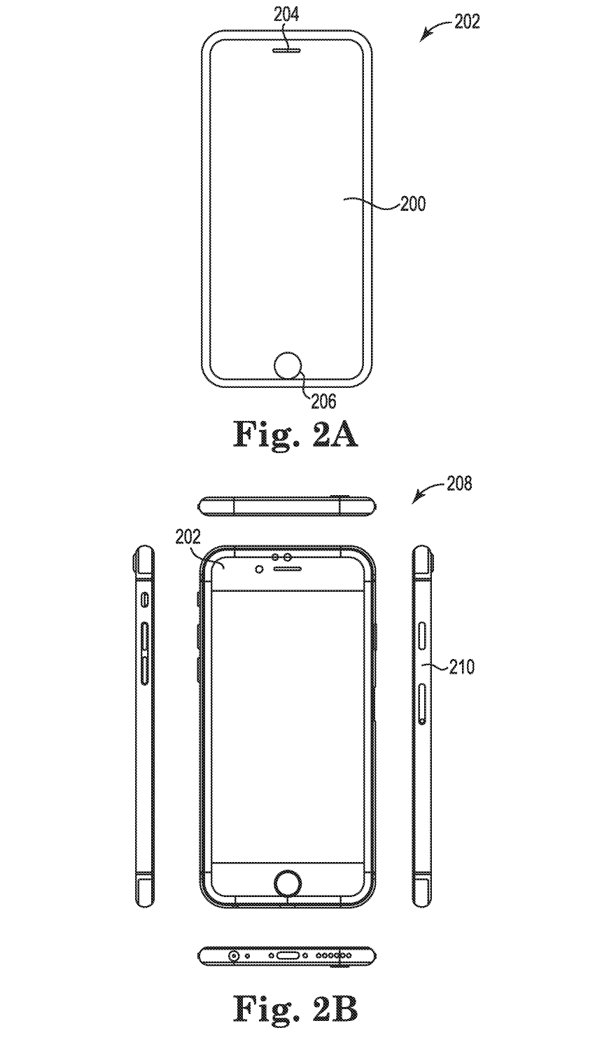

In an exemplary embodiment, as illustrated in FIGS. 2A-2B, a multi-layer polymeric protective sheet 200 is formed and sized to cover the display screen on a major top surface of the device 210 and extend around the device 210 to a portion of at least one, preferably both opposite, side surfaces of the device 210 to form a protected article 208. The portion of the side surface of the device 210 covered with a multi-layer polymeric protective sheet 200 is a major portion—i.e., greater than fifty-percent of the surface area on that side surface of the device 210—in an exemplary embodiment. The portion of the side surface of the device 210 covered with the multi-layer polymeric protective sheet 200 is a full portion—i.e., about one-hundred-percent of the surface area on that side surface of the device 210—in another exemplary embodiment.

According to a further aspect of this embodiment, a multi-layer polymeric protective sheet 200 of the invention is formed and sized to cover essentially every outwardly exposed surface of an electronic device 210—i.e., the display screen and case, except for movable push buttons (e.g., where a home button cut-out 204 can be provided in the sheet 200), speakers (e.g., where a speaker cut-out 206 can be provided in the sheet), microphones, and the like.

According to another exemplary embodiment, as illustrated in FIGS. 2C-2F, the multi-layer polymeric protective sheet 200 can be fitted to the electronic device in multiple parts, which parts in their entirety cover essentially every outwardly exposed surface of the electronic device 210. In one embodiment, the polymeric protective sheet 200 is formed into a top and bottom piece, illustrated as parts 240 and 242 in FIGS. 2C and 2D respectively, which pieces together fit around the electronic device 210 and abut or otherwise mate so that they cover essentially every outwardly exposed surface of an electronic device as described above and form the protected article 212 illustrated in FIGS. 2E and 2F.

Due to the number of different shapes and sizes of surfaces on articles that can benefit from polymeric protective sheets of the invention, it is desirable to be able to efficiently form polymeric protective sheets for application to the varying surfaces. Advantageously, the protective sheets do not include tempered glass layers and are able to be efficiently formed using thermal molding methodology—i.e., they are thermoformable. Any suitable thermal molding methodology can be used as known to those of ordinary skill in the art. In an exemplary embodiment, thermal molding methodology includes press molding of the polymeric protective sheet using heat and pressure.

In an exemplary embodiment, the polymeric protective sheets are thermally molded and cut, as needed, to the desired size and shape. Those of ordinary skill in the art are readily familiar with various methodology for cutting polymeric materials, and any suitable methodology can be used. In an exemplary embodiment, laser cutting is used to precisely cut polymeric protective sheets of the invention to the desired size and shape.

### EXAMPLES

Exemplary embodiments and applications of the invention are described in the following non-limiting examples and related testing methods.

Coefficient-of-Friction Test Method

The coefficient-of-friction of a sample was tested according to ASTM D1894 using a speed of 127 inches/minute and a 200-gram sled. The average coefficient-of-friction for samples tested is reported below in Table 1.

Loss Factor (Tan Delta) Test Method

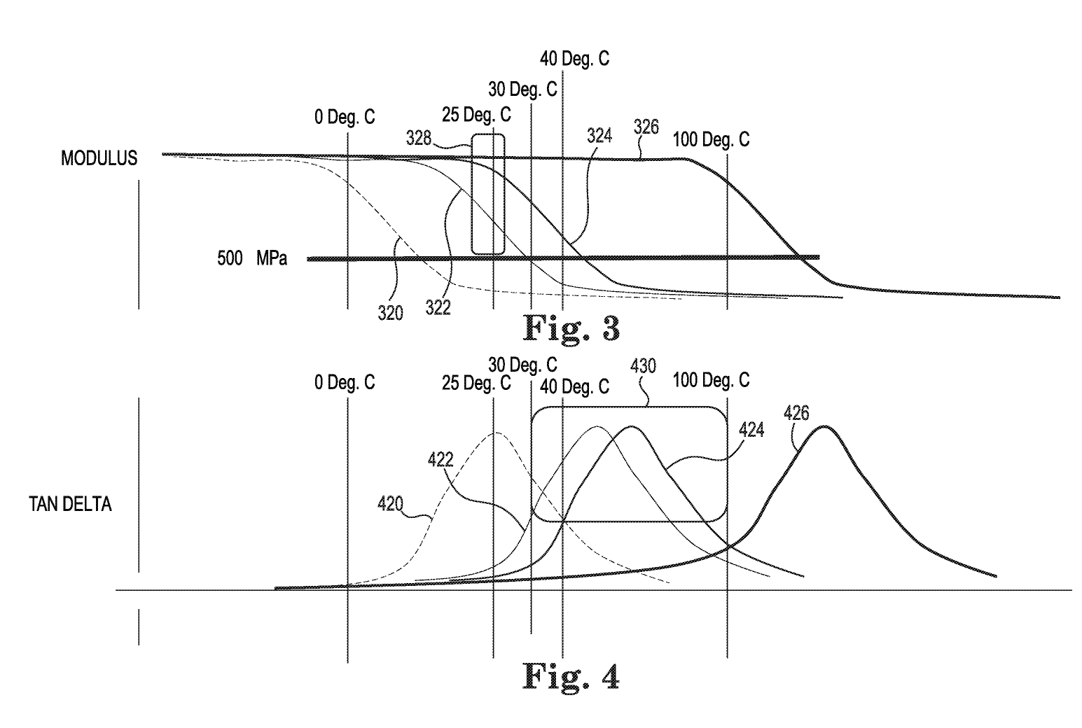

A dynamic mechanical analyzer available from TA Instruments (New Castle, Del.) under the trade designation, TA Instruments DMA Q800 was used to perform this test. Nominal sample sizes having a length of 5-12 millimeters, a width of 4-8 millimeters, and a thickness of 0.02-0.2 millimeters were used. A frequency of 1 Hz, strain of 0.3%, and ramp rate of 3° C./minute were used to measure values for determination of the loss factor (also referred to as Tan Delta) of a sample. Results are reported in FIG. 4. In a preferred embodiment, peak (i.e., maximum) tan delta values of the first polyurethane layer 112 and the second polyurethane layer 116 are within the range of values represented by box 430 in FIG. 4—i.e., at temperatures greater than about 30° C. and less than about 100° C.

Storage Modulus Test Method

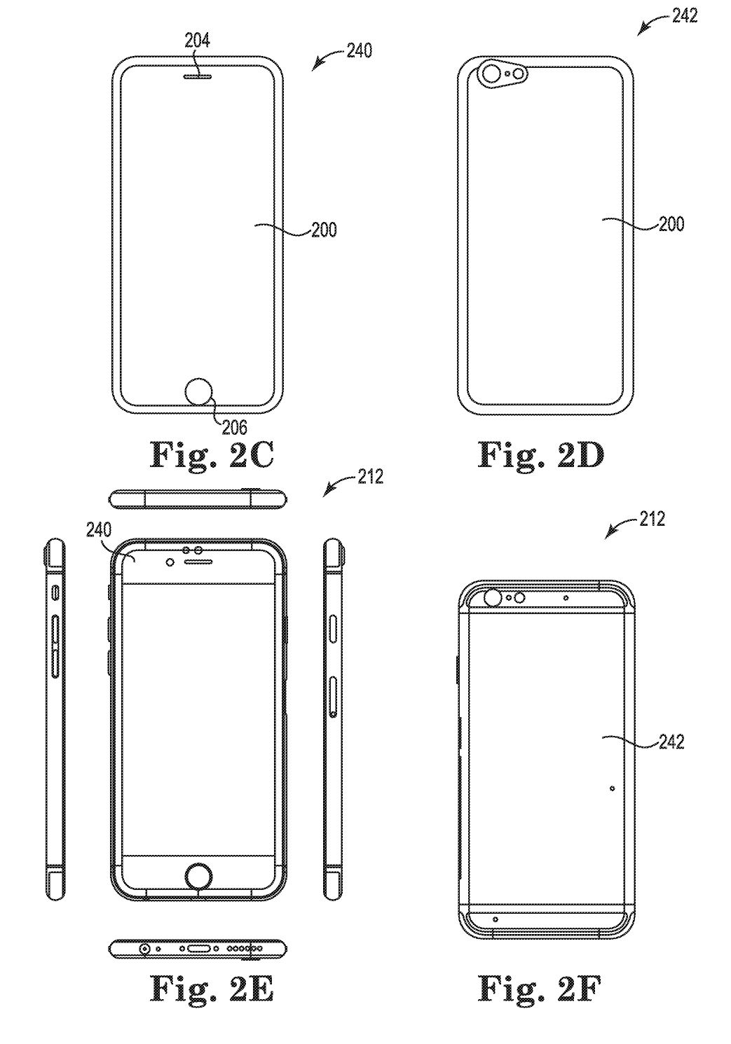

A dynamic mechanical analyzer available from TA Instruments (New Castle, Del.) under the trade designation, TA Instruments DMA Q800 was used to perform this test. Nominal sample sizes having a length of 5-12 millimeters, a width of 4-8 millimeters, and a thickness of 0.02-0.2 millimeters were used. A frequency of 1 Hz, strain of 0.3%, and ramp rate of 3° C./minute were used to measure values for determination of the storage modulus of a sample. Results are reported in FIG. 3. In a preferred embodiment, storage modulus of the first polyurethane layer 112 and the second polyurethane layer 116 is within the range of values represented by box 328 in FIG. 3—i.e., at least about 500 MPa at 25° C.

Differential Scanning Calorimetry (DSC) Test Method

The glass transition temperature of a sample is tested using a Discovery DSC tester commercially available from TA Instruments (New Castle, Del.) ramped from −10° C. to 125° C. at the rate of 10° C./minute.

### Comparative Example C1

A screen protector commercially available from Zaag, Inc. (Salt Lake City, Utah) under the INVISIBLESHIELD GLASS trade designation was tested according to the Coefficient-of-Friction Test Method. The result is reported in Table 1.

### Comparative Example C2

An original manufacturer display screen of a smartphone commercially available from Apple, Inc. (Cupertino, Calif.) under the iPhone 6 trade designation was tested according to the Coefficient-of-Friction Test Method. The result is reported in Table 1.

### Comparative Example C3

An original manufacturer display screen of a smartphone commercially available from Apple, Inc. (Cupertino, Calif.) under the iPhone 5 trade designation was tested according to the Coefficient-of-Friction Test Method. The result is reported in Table 1.

### Comparative Example C4

A hard-coated polymethylmethacrylate (PMMA) commercially available from Astra Products, Inc. (Baldwin, N.Y.) under the CLAREX Hard Coat Sheet—RH20 Flat 001 trade designation was tested according to the Coefficient-of-Friction Test Method. The result is reported in Table 1.

### Comparative Example C5

Extruded polyurethane commercially available from Argotec, LLC (Greenfield, Mass.) under the ARGOTEC 46510 trade designation was tested according to the Coefficient-of-Friction Test Method. The result is reported in Table 1.

### Comparative Example C6

Extruded polyurethane commercially available from Argotec, LLC (Greenfield, Mass.) under the ARGOTEC 49510 trade designation was tested according to the Coefficient-of-Friction, Loss Factor, and Storage Modulus Test Methods. The results are reported in Table 1 and as respective data curves 420 and 320 in FIGS. 3 and 4.

### Comparative Example C7

A layer of polycarbonate having a thickness of 178 microns (0.007 inch) available from SABIC Innovative Plastics (Boston, Mass.) under the LEXAN 8010V trade designation was tested according to the Loss Factor and Storage Modulus Test Methods. The results are reported as respective data curves 426 and 326 in FIGS. 3 and 4.

### Example 1

A layer of HM polyurethane having a thickness of 127 microns (0.005 inch) was prepared according to methodology described in U.S. Pat. No. 8,828,303 using the following components, amounts of which are provided as weight percentages based on total weight of the composition: 10.60 mid molecular weight polyol (ECA-392), 22.50 mid molecular weight polyol (ECA-464), 10.50 low molecular weight polyol (ECA-386), 1.00 ultraviolet initiator (ECA-576), 0.50 ultraviolet stabilizer (ECA-460), and 54.90 isocyanate (ECA-387). Trade designations for each component are indicated in parentheticals, with all components being commercially available from entrochem, inc. (Columbus, Ohio). The layer was tested according to the Loss Factor and Storage Modulus Test Methods. The results are reported as respective data curves 422 and 322 in FIGS. 3 and 4.

### Example 2

A layer of SHM polyurethane having a thickness of 127 microns (0.005 inch) was prepared according to methodology described in U.S. Pat. No. 8,828,303 using the following components, amounts of which are provided as weight percentages based on total weight of the composition: 8.40 mid molecular weight polyol (ECA-392), 17.80 mid molecular weight polyol (ECA-464), 12.90 low molecular weight polyol (ECA-386), 1.00 ultraviolet initiator (ECA-576), 0.50 ultraviolet stabilizer (ECA-460), and 59.40 isocyanate (ECA-387). Trade designations for each component are indicated in parentheticals, with all components being commercially available from entrochem, inc. (Columbus, Ohio). The layer was tested according to the Loss Factor and Storage Modulus Test Methods. The results are reported as respective data curves 424 and 424 in FIGS. 3 and 4.

### Example 3

Extruded polyurethane commercially available from Argotec, LLC (Greenfield, Mass.) under the ARGOTEC 49510 trade designation was topcoated with a layer of an acrylic-based polyurethane formed from aliphatic acrylic polyols and aliphatic polyisocyanate polymer, which components were polymerized on the ARGOTEC 49510 in-situ after being coated to a thickness of 10 microns. The resulting article was tested according to the Coefficient-of-Friction Test Method, with the result reported in Table 1.

### Example 4

A layer of polyurethane prepared according to Example 2 was topcoated with a layer of an acrylic-based polyurethane formed from aliphatic acrylic polyols and aliphatic polyisocyanate polymer, which components were polymerized on the layer of polyurethane in-situ after being coated to a thickness of 10 microns. The resulting article was tested according to the Coefficient-of-Friction Test Method, with the result reported in Table 1.

TABLE 1

| Example | COF (Average) |
|---|---|
| C1 | 0.316 |
| C2 | 0.527 |
| C3 | 0.324 |
| C4 | 0.755 |
| C5 | 0.697 |
| C6 | 0.861 |
| 3 | 0.347 |
| 4 | 0.323 |

Various modifications and alterations of the invention will become apparent to those skilled in the art without departing from the spirit and scope of the invention. The lack of mention or discussion of a feature, step, or component provides the basis for claims where the absent feature or component is excluded by way of a proviso or similar claim language.

Further, as used throughout, ranges may be used as shorthand for describing each and every value that is within the range. Any value within the range can be selected as the terminus of the range. Similarly, any discrete value within the range can be selected as the minimum or maximum value recited in describing and claiming features of the invention.

In addition, as discussed herein it is again noted that the composition described herein may comprise all components in one or multiple parts. Other variations are recognizable to those of ordinary skill in the art.

1. A multi-layer polymeric protective sheet comprising:
a first polyurethane layer; and
a distinct second polyurethane layer,
wherein the protective sheet is essentially free of tempered glass, and
wherein coefficient-of-friction of an outwardly exposed surface of the protective sheet is less than about 0.40.

2. The protective sheet of claim 1, wherein the coefficient-of-friction of the outwardly exposed surface of the protective sheet is less than about 0.35.

3. The protective sheet of claim 1, consisting essentially of sequential layers as follows:
a self-wetting layer;
a rigid layer;
a first adhesive bonding layer;
the first polyurethane layer;
a second adhesive bonding layer; and
the second polyurethane layer comprising the outwardly exposed surface.

4. The protective sheet of claim 1, consisting essentially of sequential layers as follows:
a self-wetting layer;
a rigid layer;
a first adhesive bonding layer;
the first polyurethane layer;
a second adhesive bonding layer;
the second polyurethane layer; and
an outermost polymeric layer comprising the outwardly exposed surface.

5. The protective sheet of claim 4, wherein the outermost polymeric layer comprises an acrylic-based polyurethane formed from aliphatic polyols and aliphatic polyisocyanate polymer.

6. The protective sheet of claim 4, wherein the outermost polymeric layer is nanomodified with sapphire.

7. The protective sheet of claim 1, wherein the first polyurethane layer has a thickness of about 100 microns to about 200 microns.

8. The protective sheet of claim 1, wherein the first polyurethane layer comprises a high modulus, thermoset, crosslinked, web-polymerized polyurethane.

9. The protective sheet of claim 1, wherein the second polyurethane layer has a thickness of about 75 microns to about 300 microns.

10. The protective sheet of claim 1, wherein the second polyurethane layer comprises a super high modulus, thermoset, crosslinked, web-polymerized polyurethane.

11. The protective sheet of claim 1, wherein storage modulus of each of the first polyurethane layer and the second polyurethane layer is at least about 500 MPa at 25° C. when tested according to the Storage Modulus Test Method, and wherein the storage modulus of the second polyurethane layer so tested is at least about 20% greater than the storage modulus of the first polyurethane layer so tested.

12. The protective sheet of claim 1, wherein storage modulus of each of the first polyurethane layer and the second polyurethane layer is at least about 1,500 MPa at 25° C. when tested according to the Storage Modulus Test Method, and wherein the storage modulus of the second polyurethane layer so tested is at least about 35% greater than the storage modulus of the first polyurethane layer so tested.

13. The protective sheet of claim 1, wherein a peak tan delta value of each of the first polyurethane layer and the second polyurethane layer occurs at a temperature of about 30° C. to about 100° C. when tested according to the Tan Delta Test Method.

14. The protective sheet of claim 1, wherein a peak tan delta value of each of the first polyurethane layer and the second polyurethane layer occurs at a temperature of about 40° C. to about 100° C. when tested according to the Tan Delta Test Method.

15. The protective sheet of claim 1, wherein glass transition temperature of each of the first polyurethane layer and the second polyurethane layer is at least about 25° C. when tested according to the DSC Test Method.

16. The protective sheet of claim 1, wherein glass transition temperature of each of the first polyurethane layer and the second polyurethane layer is at least about 35° C. when tested according to the DSC Test Method.

17. The protective sheet of claim 15, wherein the glass transition temperature of the second polyurethane layer is at least about 5° C. greater than the glass transition temperature of the first polyurethane layer so tested.

18. The protective sheet of claim 1, wherein thickness of the protective sheet is less than about 635 microns.

19. The protective sheet of claim 1, wherein thickness of the protective sheet is about 0.4 millimeter to about 2.0 millimeters.

20. The protective sheet of claim 1, wherein the protective sheet is thermoformable.

21. An article comprising at least one surface having applied to at least a portion thereof the multi-layer polymeric protective sheet of claim 1.

22. The article of claim 21, wherein the surface to which the multi-layer polymeric protective sheet is applied is a display screen of an electronic device.

23. The article of claim 22, wherein the coefficient-of-friction of the outwardly exposed surface of the protective sheet is less than a coefficient-of-friction of the underlying display screen to which the multi-layer polymeric protective sheet is applied.

24. The article of claim 22, wherein the coefficient-of-friction of the outwardly exposed surface of the protective sheet is no more than about 25% greater than a coefficient-of-friction of the underlying display screen to which the multi-layer polymeric protective sheet is applied.

25. The article of claim 22, wherein the coefficient-of-friction of the outwardly exposed surface of the protective sheet is no more than about 20% greater than a coefficient-of-friction of the underlying display screen to which the multi-layer polymeric protective sheet is applied.

26. The article of claim 22, wherein the coefficient-of-friction of the outwardly exposed surface of the protective sheet is no more than about 15% greater than a coefficient-of-friction of the underlying display screen to which the multi-layer polymeric protective sheet is applied.

27. The article of claim 22, wherein the display screen comprises a touchscreen display.

28. The article of claim 22, wherein the electronic device comprises a smartphone.

29. A method of using the protective sheet of claim 1 to protect a surface on an article, the method comprising:
providing the protective sheet of claim 1;
applying the sheet to the surface of the article.

30. The method of claim 29, wherein the surface of the article comprises a display screen on an electronic device and the protective sheet is formed and sized to not only cover the display screen to which it is applied, but also large enough to cover at least a portion of a case of the electronic device adjacent the display screen.

31. The method of claim 30, wherein the protective sheet is thermoformed

32. A method of forming the protective sheet of claim 1, wherein at least one of the first polyurethane layer and the second polyurethane layer is in-situ polymerized.

33. A method of forming the protective sheet of claim 1, wherein each of the layers within the protective sheet is formed before assembly into the protective sheet.
